(19) United States
(12) Patent Application Publication
(10) Pub. No.: US 2025/0334492 A1
(43) Pub. Date: Oct. 30, 2025

(54) DEVICE AND METHOD FOR REMOVING EXCESS MATERIAL FROM A TEST SAMPLE

(71) Applicant: TA Instruments-Waters LLC, New Castle, DE (US)

(72) Inventors: Keyvan Safaei, Newark, DE (US); Reginald Lee, West Chester, PA (US)

(21) Appl. No.: 19/190,063

(22) Filed: Apr. 25, 2025

Related U.S. Application Data
(60) Provisional application No. 63/639,379, filed on Apr. 26, 2024.

(51) Int. Cl. G01N 1/28

(52) U.S. Cl. CPC G01N 1/286; G01N 2001/2873

(57) ABSTRACT

A device for removal of excess material from a test sample includes a test geometry comprising a lower geometry and an upper geometry, wherein at least one of the upper geometry and the lower geometry is configured to move vertically with respect to the other of the upper geometry and the lower geometry and a trimming device. The trimming device includes a first arm extending to a first set of blades including a first blade and a second blade, a second arm extending to a second set of blades including a third blade and a fourth blade, and linear track system. Movement of the trimming device along the linear track system first engages the first blade and the third blade with an exterior of at least one of the upper geometry and the lower geometry, and then engages the second blade and the fourth blade with the exterior of the at least one of the upper geometry and the lower geometry.

### RELATED APPLICATION

This application claims priority to U.S. provisional patent application No. 63/639,379 filed Apr. 26, 2024 and titled “Device and Method for Removing Excess Material from a Test Sample” the entirety of which is incorporated by reference herein.

### FIELD OF THE INVENTION

The disclosed technology generally relates to a device and method for removal of excess material from a test sample. M ore particularly, the technology relates to a device and method for automated removal of excessive material from a sample to be used in an instrument for measurement of rheological and mechanical properties of the sample.

### BACKGROUND

The plate-to-plate method is used in many rheological measurements. For each test using the plate-to-plate method, after clamping the sample in between the bottom and upper plates, the user needs to manually remove the protruding portion of the material of the sample. The quality of the trim highly depends on user skill. Poor trimming can be a source of error and result in the inconsistency of test results. Trimming of excess material in this way is a skilled process that requires a trained operator, and the repeatability of measurements can therefore be affected according to the skill of the operator. Thus, having a robust, repetitive, and fast trimming process would be well received in the art.

### SUMMARY

In one aspect, a device for removal of excess material from a test sample, comprises a test geometry comprising a lower geometry and an upper geometry, wherein at least one of the upper geometry and the lower geometry is configured to move vertically with respect to the other of the upper geometry and the lower geometry, and a trimming device. The trimming device includes a first arm extending to a first set of blades including a first blade and a second blade, a second arm extending to a second set of blades including a third blade and a fourth blade, and a linear track system. Movement of the trimming device along the linear track system first engages the first blade and the third blade with an exterior of at least one of the upper geometry and the lower geometry, and then engages the second blade and the fourth blade with the exterior of the at least one of the upper geometry and the lower geometry.

Additionally or alternatively, the device further includes a motorized actuator coupled to the linear track system, the motorized actuator configured to move the trimming device and each of the first arm and the second arm along the linear track system.

Additionally or alternatively the lower geometry comprises a circular lower plate and the upper geometry comprises a circular upper plate.

Additionally or alternatively, an outer diameter of the lower geometry is greater than an outer diameter of the upper geometry.

Additionally or alternatively, the first arm is bifurcated into the first blade and the second blade such that the first blade and the second blade extend in perpendicular directions, and wherein the second arm is bifurcated into the third blade and the fourth blade such that the third blade and the fourth blade extend in perpendicular directions.

Additionally or alternatively, the first arm and the second arm are each flexible arms configured to elastically deform when the exterior of the upper geometry is engaged with at least one of the blades.

Additionally or alternatively, the linear track system is a straight track system.

Additionally or alternatively, the linear track system includes at least one curved portion, wherein the at least one curved portion is configured to match a curvature of the at least one of the upper geometry and the lower geometry.

Additionally or alternatively, the first arm and the second arm are operably attached to at least one compression spring.

Additionally or alternatively, the linear track system is a dual track structure including at least a first track and a second track.

Additionally or alternatively, the trimming device further includes a holder device, wherein the first and second arms are operably connected to the holder device, and wherein the holder device extends between and is engaged with the dual track structure.

Additionally or alternatively, the first arm is movably attached to the first track and wherein the second arm is movably attached to the second track.

Additionally or alternatively, the device further includes a motorized actuator coupled to the linear track system, the motorized actuator configured to move the trimming device and each of the first arm and the second arm along the linear track system. The motorized actuator comprises a first motorized actuator coupled to the first track to move the first arm and a second motorized actuator coupled to the second track to move the second arm such that the first arm and the second arm are independently moveable.

In another aspect, a method for removal of excess material from a test sample includes: providing a sample material between a lower geometry and an upper geometry of a rheometer; providing a trimming device including a first arm extending to a first set of blade including a first blade and a second blade, a second arm extending to a second set of blades including a third blade and a fourth blade, and a linear track system; moving each of the first arm and the second arm along the linear track system of the trimming device; and engaging the exterior of at least one of the upper geometry and the lower geometry with the first blade and the third blade and then engaging the exterior of the at least one of the upper geometry and the lower geometry with the second blade and the fourth blade during the moving.

Additionally or alternatively, the method further includes moving the upper geometry vertically with respect to the lower geometry after providing the sample material between the lower geometry and the upper geometry.

Additionally or alternatively, the method further includes removing excess of the sample material protruding from an exterior of the at least one of the upper geometry and the lower geometry during the engaging.

Additionally or alternatively, the method further includes moving each of the first arm and the second arm along the linear track system of the trimming device with a motorized actuator.

In another aspect, a blade device for removal of excess material from a test sample of a rheometer includes a first arm a first arm extending to a first set of blades including a first blade and a second blade. The first arm is bifurcated into the first blade and the second blade such that the first blade and the second blade extend in perpendicular directions.

Additionally or alternatively, the first arm is flexible and configured to elastically deform when at least one of the first blade and the second blade engages with an upper geometry of a rheometer.

Additionally or alternatively, the blade device further includes a second arm extending to a second set of blades including a third blade and a fourth blade, wherein the second arm is bifurcated into the third blade and the fourth blade such that the third blade and the fourth blade extend in perpendicular directions.

In another aspect, a device for removal of excess material from a test sample includes: a test geometry comprising a lower geometry and an upper geometry, wherein at least one of the upper geometry and the lower geometry is configured to move vertically with respect to the other of the upper geometry and the lower geometry; and a trimming device. The trimming device includes a first dual arm structure including a first arm and a second arm, the first arm extending to a first blade and the second arm extending to a second blade; a second dual arm structure including a third arm and a fourth arm, the third arm extending to a third blade and the fourth arm extending to a fourth blade; and a linear track system. Movement of the first dual arm structure and the second dual arm structure in a first linear direction engages the first blade and the third blade with an exterior of the upper geometry. Movement of the first dual arm structure and the second dual arm structure in a second linear direction engages the second blade and the fourth blade with the exterior of the upper geometry, where the second linear direction is opposite the first linear direction.

Additionally or alternatively, the device further includes a motorized actuator coupled to the linear track system, the motorized actuator configured to move each of the first dual arm structure and the second dual arm structure along the linear track system.

### BRIEF DESCRIPTION OF THE DRAWINGS

The above and further advantages of this invention may be better understood by referring to the following description in conjunction with the accompanying drawings, in which like numerals indicate like structural elements and features in the various figures. For clarity, not every element may be labeled in every figure. The drawings are not necessarily to scale, emphasis instead being placed upon illustrating the principles of the invention.

FIG. 1 depicts a side view of a test geometry for performing rheological measurements of a test sample including an upper geometry and a lower geometry, in accordance with one embodiment.

FIG. 2 depicts a perspective view of a trimming device located over the lower geometry of FIG. 1, in accordance with one embodiment.

FIG. 3 depicts a top view of trimming device of FIG. 2 located over the lower geometry, in accordance with one embodiment.

FIG. 4 depicts a perspective view of the trimming device located over the lower geometry after a sample material has been deposited on the lower geometry, in accordance with one embodiment.

FIG. 5 depicts a perspective view of the trimming device located over the lower geometry after the upper geometry has been brought down over the deposited sample material, in accordance with one embodiment.

FIG. 6 depicts a perspective view of the trimming device moving around the upper geometry to trim excess of the sample material, in accordance with one embodiment.

FIG. 7 depicts a perspective view of the trimming device after having moved around the upper geometry to trim excess of the sample material, in accordance with one embodiment.

FIG. 8A depicts a schematic view of the trimming device of FIGS. 2-7 interacting with an upper geometry in a first position, in accordance with one embodiment.

FIG. 8B depicts a schematic view of the trimming device of FIGS. 2-7 interacting with an upper geometry in a second position, in accordance with one embodiment.

FIG. 8C depicts a schematic view of the trimming device of FIGS. 2-7 interacting with an upper geometry in a third position, in accordance with one embodiment.

FIG. 8D depicts a schematic view of the trimming device of FIGS. 2-7 interacting with an upper geometry in a fourth position, in accordance with one embodiment.

FIG. 8E depicts a schematic view of the trimming device of FIGS. 2-7 interacting with an upper geometry in a fifth position, in accordance with one embodiment.

FIG. 8F depicts a schematic view of the trimming device of FIGS. 2-7 interacting with an upper geometry in a sixth position, in accordance with one embodiment.

FIG. 9 depicts a perspective view of another trimming device located proximate a test geometry, in accordance with one embodiment.

FIG. 10 depicts a top view of another trimming device located proximate a test geometry, in accordance with one embodiment.

FIG. 11 depicts a perspective view of the trimming device of FIG. 10 after moving around the upper geometry, in accordance with one embodiment.

FIG. 12 depicts a perspective view of a blade holder of the trimming device of FIGS. 10-11, in accordance with one embodiment.

FIG. 13 depicts a perspective view of another trimming device located proximate a test geometry, in accordance with one embodiment.

### DETAILED DESCRIPTION

Reference in the specification to an embodiment or example means that a particular feature, structure or characteristic described in connection with the embodiment or example is included in at least one embodiment or example of the teaching. References to a particular embodiment or example within the specification do not necessarily all refer to the same embodiment or example.

The present teaching will now be described in detail with reference to exemplary embodiments or examples thereof as shown in the accompanying drawings. While the present teaching is described in conjunction with various embodiments and examples, it is not intended that the present teaching be limited to such embodiments and examples. On the contrary, the present teaching encompasses various alternatives, modifications, and equivalents, as will be appreciated by those of skill in the art. Moreover, features illustrated or described for one embodiment or example may be combined with features for one or more other embodiments or examples. Those of ordinary skill having access to the teaching herein will recognize additional implementations, modifications, and embodiments, as well as other fields of use, which are within the scope of the present disclosure as described herein.

As used herein, “test geometry” means the two elements between which a sample material is held for measurements. The test geometry generally includes an upper geometry and a lower geometry. In some examples, the test geometry includes an upper plate and a lower plate; however, other configurations, such as cones and concentric cylinders, may be used. The plates may be circular plates and the diameters may be the same or may differ. At least one of the upper and lower geometries may be configured to move vertically with respect to the counterpart geometry. In some embodiments, one or both of the test geometries may include a heated surface for contacting the sample material deposited thereon. In some embodiments, either or both of the upper and lower geometries may be configured to rotate with respect to the counterpart geometry.

In brief overview, embodiments and examples disclosed herein are directed to a device and method for the automated removal of excess material from a test sample. The test sample may be used in an instrument for measurement of rheological and mechanical properties of the sample. The device includes a test geometry and a trimming device. The test geometry includes a lower geometry and upper geometry each having an outer edge (e.g. a circular outer edge in some embodiments). The trimming device includes at least one arm extending to at least one blade, a linear track system, and in some embodiments, a motorized actuator coupled to the trimming device and/or the linear track system. In other embodiments, the trimming device may be hand operable without a motorized actuator to provide movement thereof.

Herein, “blade” means an edged structure configured to scrape, squeegee or otherwise remove material from around an outside of one or both of the upper geometry and the lower geometry. For example, the blade may be a rubber squeegee, scraper, wire blade, or the like. Blades herein may be made of any material, and may be detachable, disposable, reusable, absorbent and/or heated.

In various embodiments, movement of the motorized actuator along the linear track engages the blade(s) with an exterior of the upper geometry in order to remove excess material from a test sample around the entire circumference of the upper geometry. In some embodiments, movement of the motorized actuator in the linear direction engages the blade(s) with an exterior of at least one of the upper geometry and the lower geometry with a variable contact force between the blade(s) and the at least one of the upper geometry and the lower geometry along the exterior of the geometry. In various embodiments, different blade structures, trimming devices, and linear tracks are contemplated, each configured to remove excess material from a test sample around the entire circumference of the upper geometry. In contrast to manual trimming techniques, the device provides many benefits, including generating repeatable sample volumes, reducing sample preparation time and/or limiting exposure of the sample to the ambient environment.

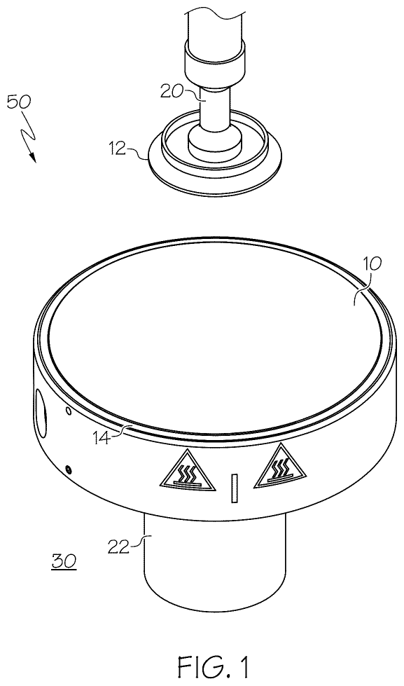

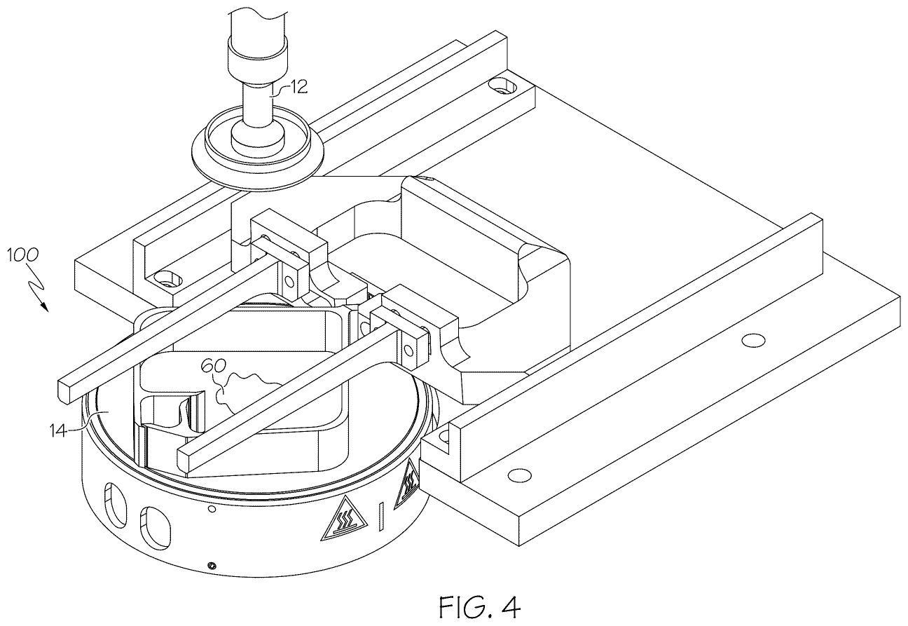

FIG. 1 depicts a side view of a test geometry 10 for performing rheological measurements of a test sample including an upper geometry 12 and a lower geometry 14, in accordance with one embodiment. The test geometry 10 may be components of a rheological test system 50 having a supporting frame 30 configured to structurally support each of the upper geometry 12 and the lower geometry 14. At least one of the upper geometry 12 and the lower geometry 14 is configured to move vertically with respect to the other of the upper geometry 12 and the lower geometry 14. For example, in contemplated embodiments, the upper geometry 12 may be configured to move relative the lower geometry 14 while the lower geometry remains stationary 14. This movement can be seen in FIGS. 4-5, described herein below.

In some embodiments, the test geometry 10 may be arranged inside a chamber that provides a controllable atmospheric composition and temperature environment for performing rheological testing. By way of nonlimiting examples, the chamber may be an oven, furnace, Peltier heater, reaction chamber or other chamber in which temperature and/or humidity may be controlled. In other embodiments, no specific environmental control chamber may be provided and the test geometry 10 may be open to the ambient environment. For example, the lower geometry may be a Peltier which is configured to heat and/or cool the sample from the bottom without the need of an enclosed chamber.

As shown, the test geometry 10 includes the upper geometry 12 and the lower geometry 14. The lower geometry 14 includes a circular lower plate having a diameter and perimeter. Likewise, the upper geometry 12 includes a circular upper plate having a diameter and perimeter smaller than that of the lower geometry 14. In other words, the outer diameter of the lower geometry 14 is greater than the outer diameter of the upper geometry 12.

Each circular plate of the upper and lower geometries 12, 14 may be attached to the end of a shaft 20, 22, respectively. The shafts 20, 22 may be attached to respective actuators and/or movement systems configured to move and/or rotate the shaft in accordance with rheological testing sequences. A sample to be tested may be positioned between the plates of the geometries 12, 14 and the plates maybe brought in close proximity with each other such that each of the geometries 12, 14 contacts the deposited sample material, creating a “test gap” between the geometries, as described and shown below.

In test preparation, the test sample may be provided by placing pellets, powder, granulates of test material, curative materials, polymers, gels, or the like onto the lower geometry 14. While not shown, in other embodiments, the lower geometry 14 may include a raised platform or dais having dimensions corresponding to the dimensions of the upper geometry upon which the test material may be placed. Whatever the embodiment, the lower geometry 14 may be configured to heat, cool and/or melt the sample. Any form of heating or cooling is contemplated.

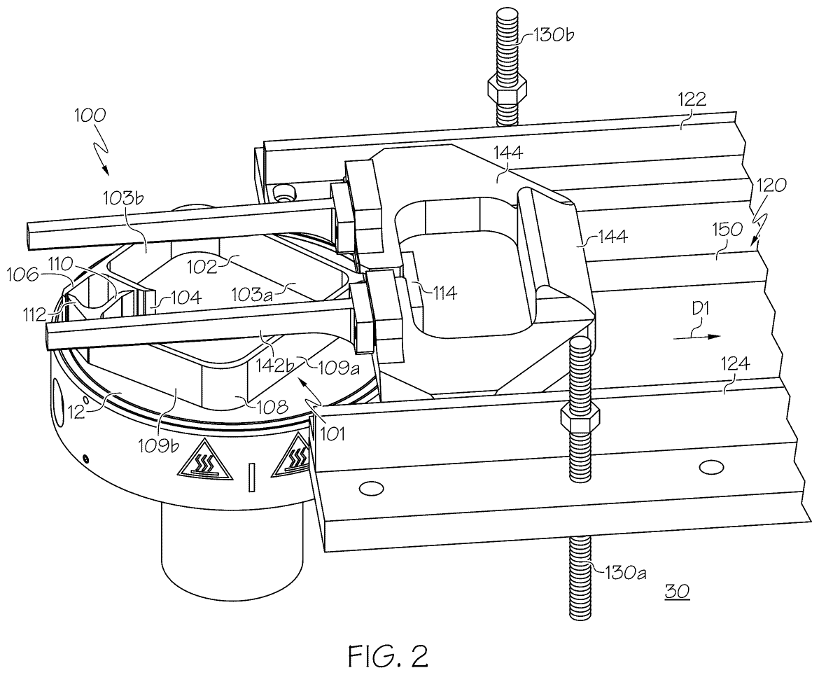

Prior to testing, the plate of the upper geometry 12 is moved upward to increase the gap (i.e. create a “loading gap”) between the upper geometry 12 and the lower geometry 14 and provide space for the sample to be placed onto the lower geometry 14. With the upper geometry 12 in the upward position, the trimmer device 100 (shown in FIG. 2) may be located in a middle position which provides a space for the sample to be placed in position. Once the sample is placed and in position, the upper geometry 12 may be lowered to a trim gap, reducing the separation between the upper and lower plates of the upper and lower geometries 12, 14, and the material is squeezed between the plates. This may result, for example, in an outward flow of the material outside the space directly below the plate of the upper geometry 12. This overflowed material must be removed before testing, so that only material located in the gap between the plates remains. As contemplated herein, an automatic linear trimmer is configured to scrape away the excess material which extends beyond the circumferential edge of the plate of the upper geometry 12. What remains after this trimming is a properly positioned test sample for rheological measurement. When fully formed and trimmed, the test sample is in the form of a uniform disk (i.e. no unintentional voids in the material) and has an outer diameter that matches the outer diameter of the plate of the upper geometry 12 and/or the raised platform or dais of the lower geometry 14 if one is deployed. Prior to or during the rheological testing, the sample may be further compressed after trimming to reach the desired edge geometry (i.e. the upper geometry may be moved even further into a smaller “test gap”).

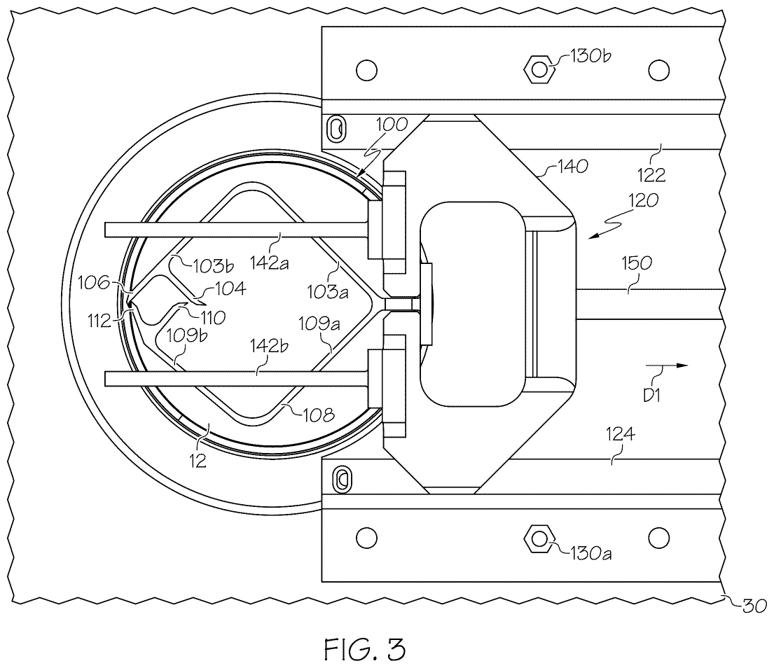

FIG. 2 depicts a perspective view of a trimming device 100 located over the lower geometry 14 of FIG. 1, in accordance with one embodiment. In this view, the upper geometry 12 shown in FIG. 1 has been removed from the view in order to reveal the trimming device 100. Reference is also made to FIG. 3, which depicts a top view of trimming device 100 of FIG. 2 located over the lower geometry 14, in accordance with one embodiment. The trimming device 100 includes a blade device 101 having a first arm 102 or arm structure extending to a first set of blades including a first blade 104 and a second blade 106. The trimming device 100 further includes a second arm 108 or arm structure extending to a second set of blades including a third blade 110 and a fourth blade 112.

In addition to the blade device 101, the trimming device 100 further includes a linear track system 120, a holder device 140, and an actuator 150. Specifically, the holder device 140 is located within the linear track system 120 and connected to the actuator 150 such that the holder device 140 is engaged with and extends between dual rails 122, 124 the linear track system 120 so that actuation by the actuator moves the holder device 140 along the linear track system 120. The blade device 101, including the first and second arms 102, 108 thereof, is operably connected to the holder device 140 through an attachment interface 114. Thus, the movement of the actuator 150 and/or the holder device 140 is configured to move each of the first arm 102 and the second arm 108 along the linear track system. Movement of the holder device 140 in a first linear direction D1 engages the blades with an exterior of the upper geometry 12 as shown in FIGS. 4-8.

While an automated and/or motorized actuator 150 is contemplated which automatically causes the trimming device 100 to perform trimming in an automated or robotic manner, the blade device 101 may alternatively operate via a facilitated manual procedure whereby an operator grips the holder device 140 and moves the holder device 140 along the linear track system 120 in the first linear direction D1 to perform the material trimming. Such a manual process would require no trimming skill compared to conventional processes because the blade device 101 may perform trimming guided only by the predefined linear motion of the holder device 140 within the linear track system 120. In the embodiment shown, the actuator 150 may be a motorized actuator, whereby a motor creates mechanical movement of the post 150 along the linear track system 120. Further, the actuator 150 may be automated and/or connected to a computer system or other control system, and may allow a user to determine when the actuator 150 moves.

The linear track system 120 may be positioned at a height above the frame 30 of the rheological test system 50. In particular, the linear track system 120 may include openings through which a pair of bolts 130a, 130b extend. The height of the linear track system 120 may be adjustable based on the adjustment of the bolts 130a, 130b. While two bolts are shown, any mechanical arrangement is contemplated in order to affix the linear track system 120 to the frame 30 of the rheological test system 50.

The holder device 140 may be keyed to the linear track system 120 such that the holder device 140 is movable between the dual rails 122, 124. Thus, the holder device 140 may have a width which corresponds to a width between the dual rails 122, 124. While the linear guides are shown according to one embodiment, any types of linear rail structure and/or holder structure may be used. The holder device 140 may further include a pair of retainers 142a, 142b extending from the base of the holder device 140 over the blade device 101. The retainers 142a, 142b may be in contact with the arms 102, 108 of the blade device and may be configured to maintain the arms 102, 108 and prevent movement thereof in a vertical direction during operation and trimming. The retaining mechanism is not limited to the shown design. Any types retaining mechanism used to maintain the blades and facilitate the described linear motion of the blades is contemplated. Moreover, in some embodiments, no retainers are used and the structural integrity of the blades is sufficient without retainers.

The blade device 101 includes each of the first arm 102 and the second arm 108, which may each be flexible arms configured to elastically deform when one or more of the blades 104, 106, 110, 112 become engaged with an exterior of the upper geometry during the movement of the blade device 101 caused by movement of the holder device 140 in the first linear direction D1. While the embodiment shown includes engaging with the upper geometry, in other embodiments, engagement of the blade device 101 may occur instead with the lower geometry or both geometries, depending on the dimensions of the geometries and which geometry is larger. The first arm 102 and the second arm 108 may each extend outwardly from the attachment interface 114 at approximately 90 degrees apart from each other. The first and second arms 102, 108 include a curve or bend which curves the arms 102, 108 approximately 90 degrees back toward each other. Thus, the arms 102, 108 form a shape resembling a square or rectangle. The square or rectangular shape may be dimensioned to provide sufficient clearance to receive the circular plate of the upper geometry 12 after the test material is provided on the lower geometry 14 and when the upper geometry 12 is lowered onto the material to close the gap. In other embodiments, the first and second arms 102, 108 may be spaced apart by any amount and may be disposed at any respective angles.

The first arm 102 of the blade device 101 comes to an end and is bifurcated into the first blade 104 and the second blade 106 such that the first blade 104 and the second blade 106 extend in perpendicular directions from each other. Likewise, the second arm 108 comes to an end and is bifurcated into the third blade 110 and the fourth blade 112 such that the third blade 110 and the fourth blade 112 extend in perpendicular directions from each other. The first and the second blades 104, 106 face generally the third and the fourth blades 110, 112. The third blade 110 and the fourth blade 112 are each spaced closer together than the first blade 104 and the second blade 106 such that the third blade 110 and the fourth blade 112 are located between the first and the second blades 104, 106. However, other arrangements are contemplated, such the first and second blades 104, 106 and the third and fourth blades 110, 112 having even and/or symmetrical spacing. In some embodiments, the blade pairs may be offset from each other in a linear direction of movement D1 such that, for example, the first blade 104 contacts the geometry first, followed by the third blade 110, the second blade 106, and the fourth blade 112 as the device 100 moves in the direction of movement D1. Any blade angles, sizing, symmetry, asymmetry and/or blade offset is contemplated, depending on the geometry size and other design considerations.

Referring now to FIGS. 4-7, perspective views of a trimming process are shown in accordance to embodiments described herein. In particular, FIG. 4 depicts a perspective view of the trimming device 100 located over the lower geometry 14 after a sample material 60 has been deposited on the lower geometry 14, in accordance with one embodiment. Deposit of the sample material 60 may occur before or after the trimming device 100 is positioned over the lower geometry 14 as shown. As depicted, the depositing of the sample occurs before the upper geometry 12 is lowered onto the deposited sample material 60 to close the gap. FIG. 5 depicts a perspective view of the trimming device 100 located over the lower geometry 14 after the upper geometry 12 has been brought down over the deposited sample material 60 to close the gap, in accordance with one embodiment.

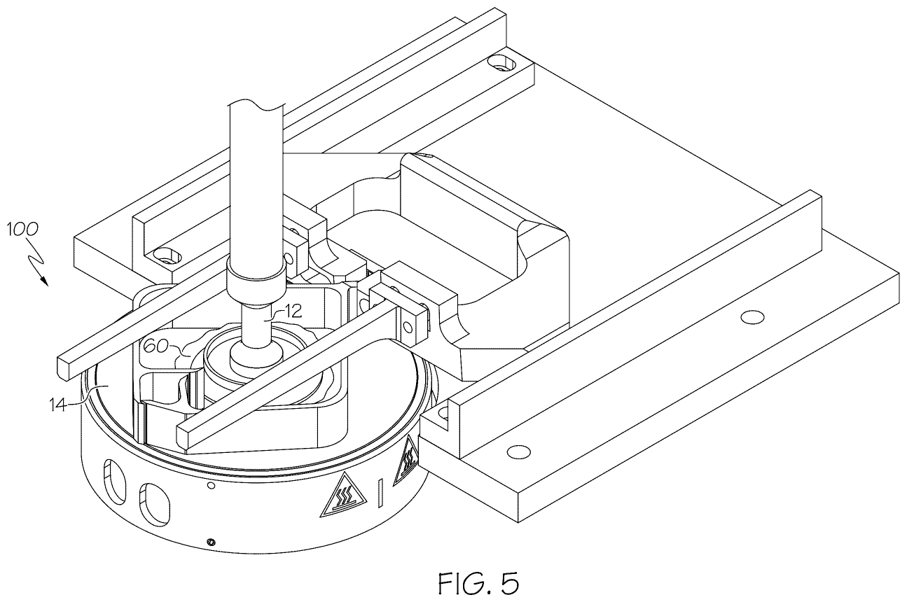

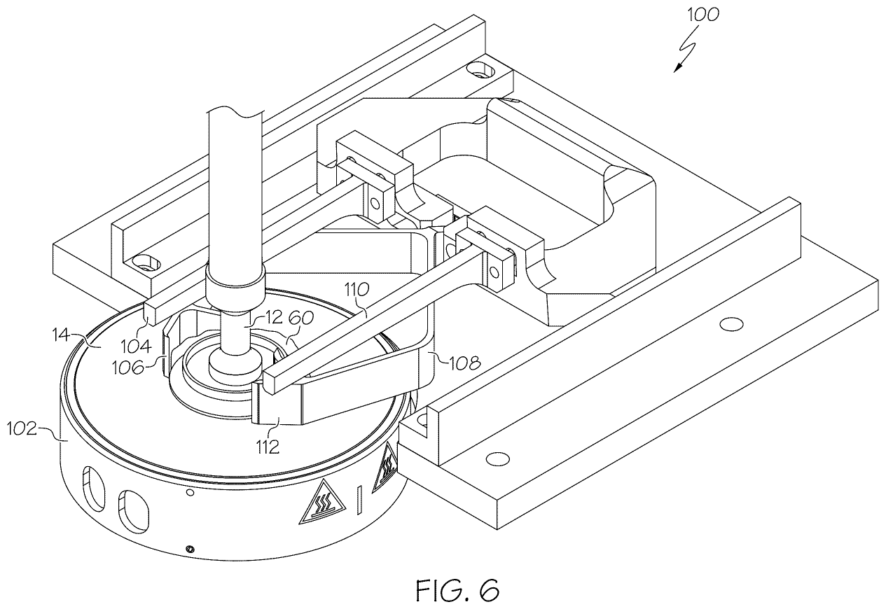

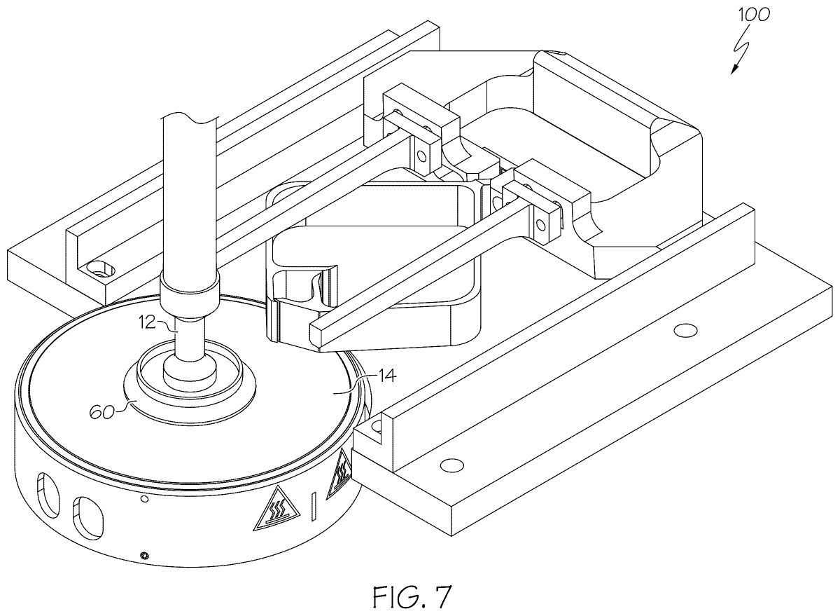

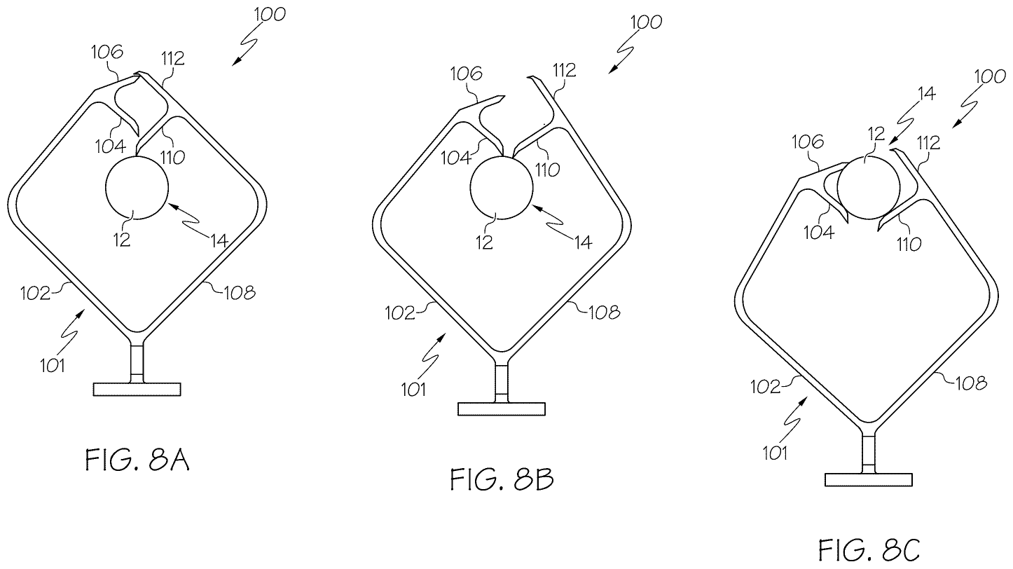

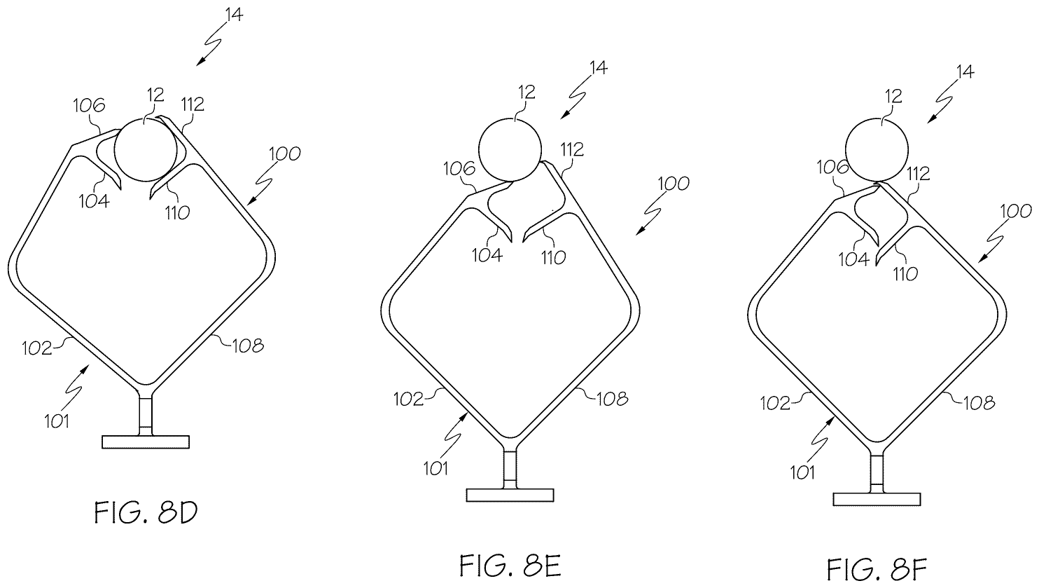

FIG. 6 depicts a perspective view of the trimming device 100 moving around the upper geometry 12 to trim excess of the sample material 60 located outside the gap, in accordance with one embodiment. At this point in the process, the first blade 104 of the first arm 102 is beginning to disengage from the upper geometry 12 while the second blade 106 of the first arm 102 is beginning to engage. The third blade 110 of the second arm 108 remains engaged with the upper geometry 12 in this position, as the second arm 108 lags the first arm 102 in the cutting process. More details of the geometry during cutting are described herein below and shown in FIGS. 8A-8F. FIG. 7 depicts a perspective view of the trimming device 100 after having moved around the upper geometry 12 to trim excess of the sample material 60, in accordance with one embodiment. As shown, the excess sample material 60 located outside the bounds of the circular plate of the upper geometry 12 has been completely removed by the trimming device 100 with a single linear motion of the blade device 101.

FIG. 8A depicts a schematic view of the trimming device 100 of FIGS. 2-7 interacting with an upper geometry 12 in a first position, in accordance with one embodiment. In the first position shown, the third blade 1110 of the second arm 108 is the first of the blades 104, 106, 110, 112 to make contact with the upper geometry 12. This point of contact occurs at or around a topmost point of the upper geometry 12 in the view shown. At this first position, the third blade 110 of the second arm 108 has contacted the upper geometry 12 but the first blade 104 of the first arm 102 has not. As shown clearly in the top view, each of the blades 104, 106, 110, 112 may extend to a curved end. The curved end of each of the blades 104, 106, 110, 112 is curved in a direction to create an initial approximately perpendicular angle between the blades 104, 106, 110, 112 and the upper geometry 12 at the initial point of contact. However, any angle of contact between the blades and the geometry or geometries is contemplated.

FIG. 8B depicts a schematic view of the trimming device 100 of FIGS. 2-7 interacting with an upper geometry 12 in a second position, in accordance with one embodiment. In the second position shown, the third blade 110 continues to move around the upper geometry, bending the second arm 108, and remaining in contact as the blade device 101 is moved downward along the linear track (not shown). Thus, each of the first arm 102 and the second arm 108 may be flexible and configured to elastically deform when the blades 104, 106, 110, 112 engage with an upper geometry 12. In other embodiments, the first arm 102 and the second arm 108 may be rigid but connected to a flexible or spring hinge system to allow for the arms to be opened. At this second position, the first blade 104 of the first arm 102 is the second of the blades 104, 106, 110, 112 to make contact with the upper geometry 12. This contact occurs at or around the same point of engagement of the first blade 104, which is at the topmost point of the upper geometry 12 in the view shown. In some embodiments the blades 110, 104 may include a slight overlap (e.g., the third blade 110 contacts the upper geometry 12 to the left of the midpoint, while the first blade 104 contacts the upper geometry 12 at the right of the midpoint).

FIG. 8C depicts a schematic view of the trimming device 100 of FIGS. 2-7 interacting with an upper geometry 12 in a third position, in accordance with one embodiment. In the third position shown, the third blade 110 is at the point of disengagement from the upper geometry 12. This point of disengagement is located more than 90 degrees from the point of original engagement, although the exact disengagement point may be variable based on design constraints. At this point, the second blade 106 of the first arm 102 has engaged with the upper geometry 12 at a point that is less than 90 degrees from the top point of initial engagement of the upper geometry 12. The first blade 104 of the first arm 102 remains engaged with the upper geometry 12 while the fourth blade 112 has not yet engaged.

FIG. 8D depicts a schematic view of the trimming device 100 of FIGS. 2-7 interacting with an upper geometry 12 in a fourth position, in accordance with one embodiment.

In the fourth position shown, the second blade 106 continues to engage the upper geometry 12 while the first blade 104 has fully disengaged. At this point, the third blade 110 of the second arm 108 is also disengaged while the fourth blade 112 is at the point of engagement that is less than 90 degrees from the top point of initial engagement of the upper geometry 12.

FIG. 8E depicts a schematic view of the trimming device 100 of FIGS. 2-7 interacting with an upper geometry 12 in a fifth position, in accordance with one embodiment. In the fifth position shown, the second blade 106 is at the point of disengagement from the upper geometry 12. This point of disengagement is at or approximately directly across from the point of engagement of the third blade 110 and the first blade 104, and is at the bottom of the upper geometry 12 in the view shown. At this point, the first arm 102 has returned to an unflexed or undeformed state.

FIG. 8F depicts a schematic view of the trimming device of FIGS. 2-7 interacting with an upper geometry in a sixth position, in accordance with one embodiment. In the sixth position shown, the second blade 106 is fully disengaged, while the fourth blade 112 is at the point of disengagement from the upper geometry 12. This point of disengagement is at or approximately directly across from the point of engagement of the third blade 110 and the first blade 104 and at or approximately at the same location as the point of disengagement of the second blade 106.

Based on the flexible nature of the blade device 101, movement of the actuator 150 and/or holder device 140 in the first linear direction D1 engages the blades 104, 106, 110, 112 with an exterior of the upper geometry 12 with a contact force between the blades 104, 106, 110, 112 and the upper geometry 12 along the exterior of the upper geometry through the motion of the blades. The contact force between the blades 104, 106, 110, 112 and the upper geometry 12 during the movement of the actuator 150 and/or holder device 140 is created by a spring force in the arms 102, 108 being bent during the movement. Furthermore, the contact angle between the blades 104, 106, 110, 112 and the exterior of the upper geometry 12 also may vary through the movement of the blade device 101 and may be particularly tailored based on design constraints. Thus, the amount of contact force and blade angles may be altered from the embodiment shown, as well as the stiffness or flexibility of the arms 102, 108. Whatever the embodiment, the angle and stiffnesses may be sufficient to remove or trim the excess material located outside the bounds of the upper geometry 12.

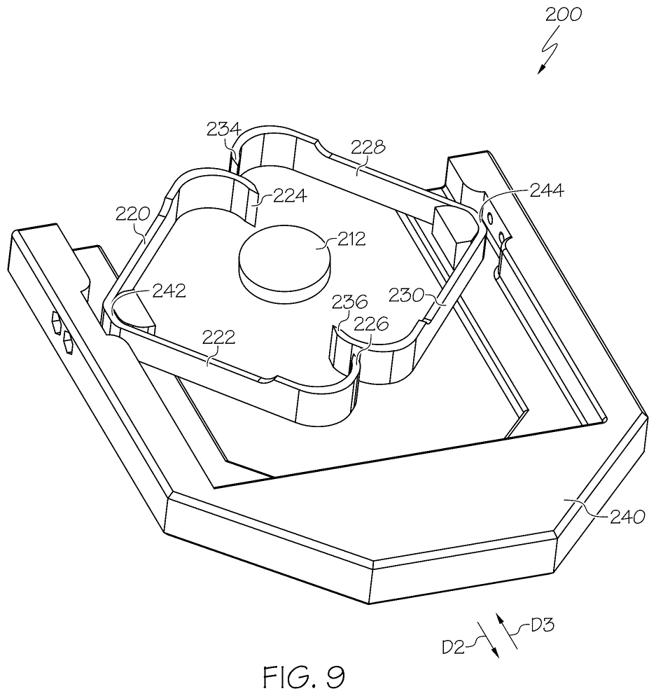

FIG. 9 depicts a perspective view of another trimming device 200 located proximate a test geometry, in accordance with one embodiment. The trimming device 200 may operate in a linear fashion similar to the embodiment as the trimming device 100. However, unlike the trimming device 100 described above in which a single move in the direction D1 performs the entire trimming process, the trimming device 200 may be configured to perform trimming via two moves, one in a direction D2, and another in an opposite direction D3. While not shown, the moves of the trimming device 200 may be performable by manual handling, or by an automated system performed by an actuator, as described above.

The trimming device 200 may be implemented on a rheological test system, such as the rheological test system 50 described herein above, and include a lower geometry (not shown) and an upper geometry 212, similar or the same as the test geometry 10 and the upper and lower geometries thereof 12, 14. Thus, at least one of the upper geometry 212 and the lower geometry may be configured to move vertically with respect to the other of the upper geometry 212 and the lower geometry.

The trimming device 200 includes a dual arm structure including a first arm 220 and a second arm 222. The first arm 220 extends to a first blade 224 and the second arm 222 extends to a second blade 226. Similarly, the trimming device 200 includes a second dual arm structure including a third arm 228 and a fourth arm 230. The third arm 228 extends to a third blade 234 and the fourth arm 230 extends to a fourth blade 236. While each of the arms 220, 222, 228, 230 each extend to a single blade in the embodiment shown, in other embodiments, each of the arms 220, 222, 228, 230 may extend to more than one blade. Further, while the arms 220, 222 and the arms 228, 230 are connected as shown, in other embodiments these components may be separable or separate.

The first dual arm structure, including the first arm 220 and the second arm 222, may be attached to a holder device 240 at a first attachment interface 242. Similarly the second dual arm structure, including the third arm 228 and the fourth arm 230, may be attached to the holder device 240 at a second attachment interface 244. The first and second attachment interfaces 242, 244 may be configured to hold and retain the dual arm structures to the holder device 240. Any holding device or structure is contemplated. For example, in the case that the arms 220, 222 and the arms 228, 230 are separate from each other, each of the individual arms may include a separate holder.

The holder device 240 may be located within a linear track system (not shown) which may be the same or similar to the linear track system 120 shown herein above. This linear track system may be connected to an actuator (not shown) such that the holder device 240 is engaged with and extends between dual rails the linear track system so that actuation by the actuator moves the holder device 240 along the linear track system. The dual arm structures may be operably connected to the holder device 240 through an attachment interfaces 242, 244, respectively, such that the movement of the actuator and/or the holder device 240 is configured to move each of the first arm 220, the second arm 222, the third arm 228 and the fourth arm 230 along the linear track system. Movement of the holder device 240 in a linear direction D2 engages the first blade 224 and the third blade 234 with an exterior of the upper geometry 212. Likewise, movement of the holder device 240 in an opposite linear direction D3 engages the second blade 226 and the fourth blade 236 with an exterior of the upper geometry 212. Thus, completed trimming may be performed by the trimming device 200 via a first move in one of the directions D2, D3, and then a second move in the other of the directions D2, D3. While the embodiment shown includes blades at a chosen attack angle, the attack angle of the blades and the flexibility of the arms may be adjustable, tuned or otherwise changed by changing the geometry of the blades or the flexibility of the arm material.

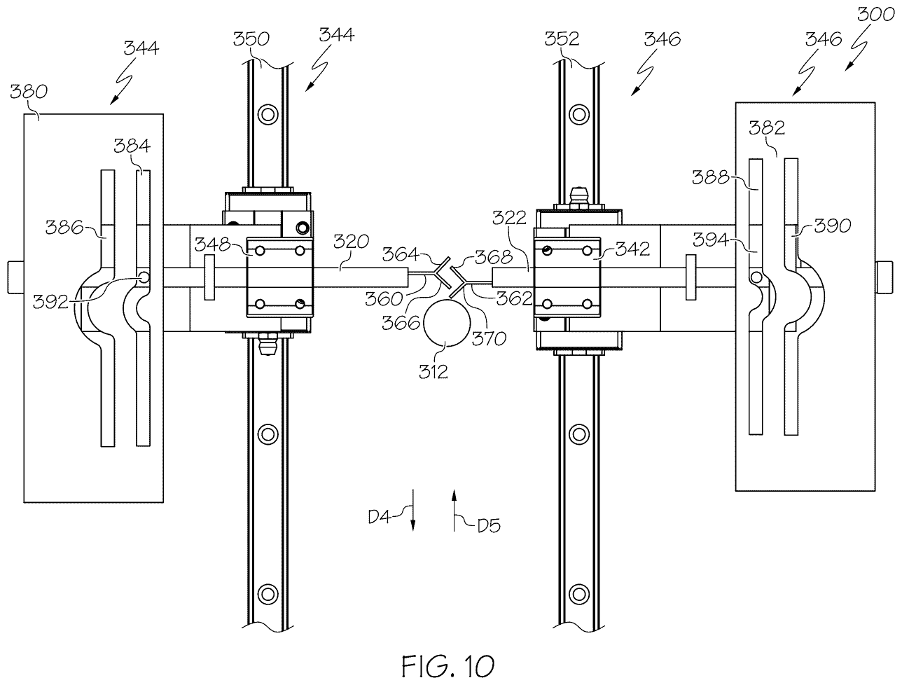

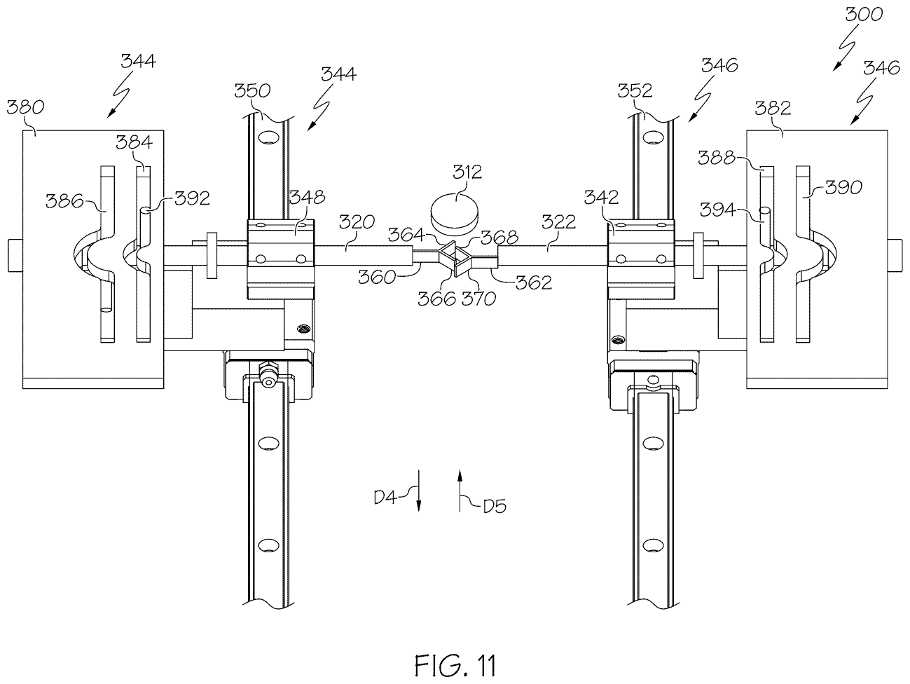

FIG. 10 depicts a top view of another trimming device 300 located proximate a test geometry, in accordance with one embodiment. Reference is also made to FIG. 11, which depicts a perspective view of the trimming device 300 of FIG. 10 after moving around the upper geometry 312, in accordance with one embodiment.

The trimming device 300 may operate in a linear fashion similar to the embodiments described herein above. However, unlike the trimming devices 100, 200 described above in which each of the blades of the trimming device 300 is connected to a single holder device, the trimming device 300 includes a first holder device 340 and a second holder device 342 which are each independently movable along a first linear track system 344 and a second linear track system 346, respectively. While not shown, the moves of the trimming device 300 may be performable by manual handling the respective holder devices 340, 342, or by an automated system performed by one or more actuators, as described above. Furthermore, while independent motion is contemplated, it is also contemplated that a single drive may be used to move the trimming device 300.

The trimming device 300 may be implemented on a rheological test system, such as the rheological test system 50 described herein above, and include a lower geometry (not shown) and an upper geometry 312, similar or the same as the test geometry 10 and the upper and lower geometries thereof 12, 14. Thus, at least one of the upper geometry 312 and the lower geometry may be configured to move vertically with respect to the other of the upper geometry 312 and the lower geometry.

The trimming device 300 includes a dual arm structure including a first blade holder arm 320 and a second blade holder arm 322. The first blade holder arm 320 is attached to the first holder device 340 at a first attachment interface 348 and the second blade holder arm 322 is attached to the second holder device 342 at a second attachment interface 349. The blade holder arms 320, 322 each extend to respective dual blade structures, 360, 362. The first dual blade structure 360 comes to a bifurcated end from which a first blade 364 and a second blade 366 extend at perpendicular directions from each other. Likewise, the second dual blade structure 362 comes to a bifurcated end from which a third blade 368 and a fourth blade 370 extend at perpendicular directions from each other.

The first holder device 340 may be operably attached to the first linear track system 344. In particular, the first linear track system 344 may include a first rail 350 upon which the first holder device 340 is attached and mounted. Likewise, the second linear track system 346 may include a second rail 352 upon which the second holder device 342 is attached and mounted. The first holder device 340 may be configured to independently move along the first rail 350 relative to the movement of the second holder device 342 moving along the second rail 352.

In addition to the movement along the rails 350, 352, the dual blade structures 360, 362 may also be configured to move in a directional axis that is perpendicular to the rails 350, 352. This perpendicular movement is accomplished by the first and second linear track systems 344, 346 having respective guiding plates 380, 382. A first guiding plate 380 includes an inner track opening 384 including a first semicircular curved opening located between two straight openings. Similarly, the first guiding plate 380 includes an outer track opening 386 including a wider semicircular curved opening located between two straight openings. Like the first guiding plate 380, the second guiding plate 382 includes both inner and outer track openings 388, 390 including respective semicircular curved openings located between straight openings. The first blade holder arm 320 includes a keyed protrusion 392 configured to remain within the inner track opening 384. The first attachment interface 348 allows for the lateral motion of the blade holder arm 320 created by the semicircular portion of the inner track opening 384. Likewise, the second blade holder arm 322 includes a similar keyed protrusion 394 configured to remain within the inner track opening 388 while the second attachment interface 349 allows for the lateral motion of the blade holder arm 322 created by the semicircular portion of the inner track opening 388. The inner track openings 384, 388 may be configured to accommodate the dimensions of the upper geometry 312, while the outer track openings 386, 390 may be configured to accommodate the dimensions of another geometry having larger dimensions than the upper geometry 312, for example. For example, if a 20 mm smaller geometry is deployed, the inner track openings may be used, while if a 40 mm larger geometry is deployed, the outer track openings may be used.

Any number of track opening pairs are contemplated in this embodiment to accommodate the dimensions of any geometries. Furthermore, while a semicircular portion of the openings are contemplated to accommodate stiff blade holder arms, other embodiments may include any shaped opening tracks. For example, if a greater pressure is desired at a midpoint of the trimming (i.e. 90 degrees from the initiation of the trim), a lesser curve may be deployed, and a semi-flexible blade holder arm may be deployed. Thus, the contact force between the blades and the upper geometry 312 during movement may be changed by the curvature of the linear track system and the various track openings 384, 386, 388, 390 thereof. The openings in the track system may be configured to adjust and control the force along the trimming circumference.

While not shown, the holder devices 340, 342 may be connected to one or more actuators (not shown) such that the holder devices 340, 342 independently move along the first and second linear track systems 344, 346. To trim excess material, the trimming device 300 may include either one or two moves. In a two-move embodiment, the trimming device 300 may move in a back and forth motion-one in a direction D4, and another in an opposite direction D5. These moves may be accomplished in any order and in any sequence between the holder devices 340, 342 (i.e. holder devices 340, 342 may move sequentially or simultaneously to perform trimming).

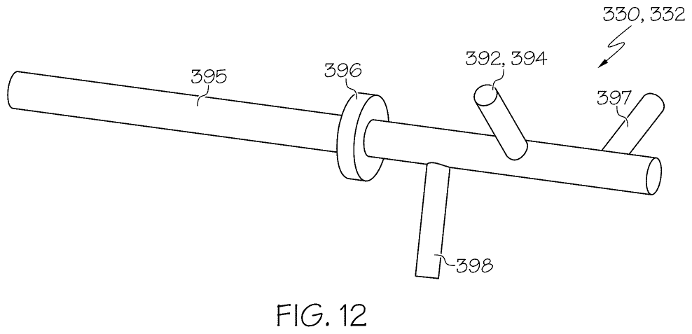

FIG. 12 depicts a perspective view of one of the blade holder arms 320, 322 of the trimming device of FIGS. 10-11, in accordance with one embodiment. The blade holder arm 320, 322 is divided by a stopper 396 between a first end 395 and a second end 399. The first end 395 interfaces with the attachment interfaces 348, 349 and allows for horizontal movement therein up to the point of the stopper 396. The second end 399 includes a plurality of keyed protrusions 398, 392, 394, and 397. The keyed protrusions 398, 392, 394, and 397 are radially disposed about the second end 399 in order that only one may be active and within a track opening 384, 386, 388, 390 at a time. Thus, each of the keyed protrusions 398, 392, 394, and 397 may be particularly keyed to a different track opening. While there are three keyed protrusions shown, any number of protrusions and tracks and track openings are contemplated.

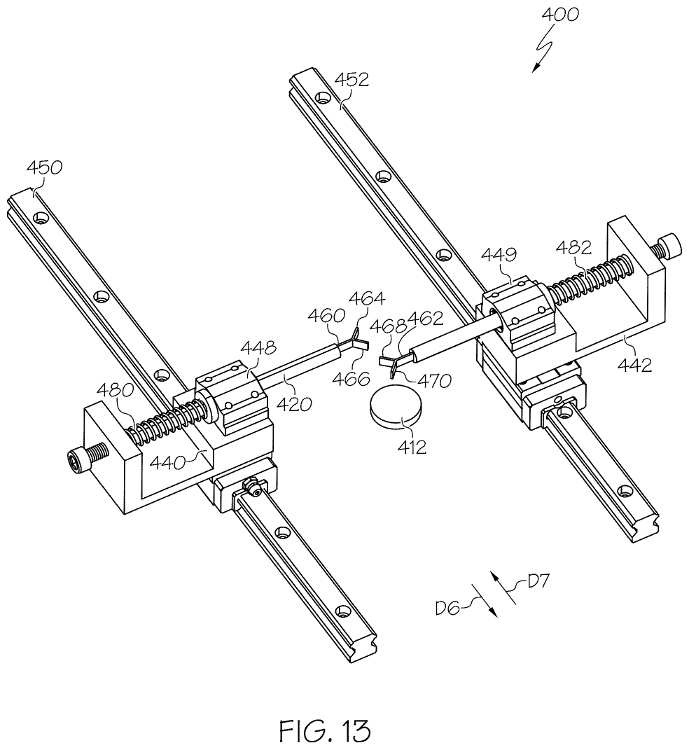

FIG. 13 depicts a perspective view of another trimming device 400 located proximate a test geometry 412, in accordance with one embodiment. The trimming device 400 may operate in a linear fashion similar to the embodiments described herein above. However, unlike the trimming devices 100, 200 described above in which each of the blades of the trimming device is connected to a single holder device, the trimming device 400 includes a first holder device 440 and a second holder device 442 which are each independently movable along a first linear track 450 and a second linear track 452, respectively. While not shown, the moves of the trimming device 400 may be performable by manual handling the respective holder devices 440, 442, or by an automated system performed by one or more actuators, as described above.

The trimming device 400 may be implemented on a rheological test system, such as the rheological test system 50 described herein above, and include a lower geometry (not shown) and an upper geometry 412, similar or the same as the test geometry 10 and the upper and lower geometries thereof 12, 14. Thus, at least one of the upper geometry 412 and the lower geometry may be configured to move vertically with respect to the other of the upper geometry 412 and the lower geometry.

The trimming device 400 includes a dual arm structure including a first blade holder arm 420 and a second blade holder arm 422. The first blade holder arm 420 is attached to the first holder device 440 at a first attachment interface 448 and the second blade holder arm 422 is attached to the second holder device 442 at a second attachment interface 449. The blade holder arms 420, 422 each extend to respective dual blade structures, 460, 462. The first dual blade structure 460 comes to a bifurcated end from which a first blade 464 and a second blade 466 extend at perpendicular directions from each other. Likewise, the second dual blade structure 462 comes to a bifurcated end from which a third blade 468 and a fourth blade 470 extend at perpendicular directions from each other.

The first holder device 440 is operably attached to the first linear track 450 while the second holder device 450 is operably attached to the second linear track 460. The first holder device 440 may be configured to independently move along the first rail 450 relative to the movement of the second holder device 442 moving along the second rail 452.

In addition to the movement along the first and second linear tracks 450, 462, the dual blade structures 460, 462 may also be configured to move in a directional axis that is perpendicular to the first and second linear tracks 450, 462. This perpendicular movement is accomplished by the first and second blade holder arms 420, 422 being operably attached to first and second compression springs 480, 482. Thus, the first and second compression springs 480, 482 may provide for motion perpendicular to the primary linear movement of the trimming device 400 in order to accommodate the dimensions of the upper geometry 412. The compression springs 480, 482 may be caused to compress by varying degrees during movement, by varying the flexibility of the arms 420, 422 and/or blades thereof, or by varying the dimensions of the upper geometry 412. Further, various spring constants may be deployed for varying degrees of stiffness and trimming force.

While not shown, the holder devices 440, 442 may be connected to one or more actuators (not shown) such that the holder devices 440, 442 independently move along the first and second linear tracks 450, 452. To trim excess material, the trimming device 400 may require two moves-one in a direction D6, and another in an opposite direction D7. These moves may be accomplished in any order and in any sequence between the holder devices 440, 442 (i.e. holder devices 440, 442 may move sequentially or simultaneously to perform trimming).

Various methods of trimming are also contemplated using the various contemplated devices described herein. For example, methods of removal of excess material from a test sample may include providing a sample material between a lower geometry and an upper geometry of a rheometer. Methods may include providing a trimming device, such as any of the trimming devices described herein above which include a four blade structure and at least two arms. Methods include moving the upper geometry vertically with respect to the lower geometry after providing the sample material between the lower geometry and the upper geometry.

Methods include moving each of the at least two arms along the linear track system with movements of a motorized actuator. Methods further include engaging the exterior of the upper geometry with a first blade of a first arm, and a third blade of a second arm, then engaging the upper geometry with a second blade of the first arm and a fourth blade of the second arm.

Methods include removing excess of the sample material protruding from an exterior of the outer geometry during the engaging the exterior of the upper geometry with the first blade and the third blade during movement of the actuator in the first linear direction, and removing excess of the sample material protruding from an exterior of the outer geometry during the engaging the exterior of the upper geometry with the second blade and the fourth blade during movement of the actuator in the second linear direction.

Methods may include moving removing excess of the sample material by moving the blades in a single direction. In other embodiments, methods may include removing excess of the sample material by moving the blades in a first direction, and then moving the blades in a second opposite direction.

Methods may further include engaging the exterior of the upper geometry with the blades during movement of the actuator in a first linear direction with a contact force between the first blade and the upper geometry along the exterior of the upper geometry.

Methods may further include tuning the contact force by changing a material of the first arm to a material having a different elastic modulus. Methods may further include tuning the variable contact force by changing the linear track system to produce a different motions of the first arm, such as by different guiding plates as shown in FIGS. 10-11. Still further, methods may include tuning the contact force by changing the angle of the blades relative to the geometry or geometries.

While various examples have been shown and described, the description is intended to be exemplary, rather than limiting and it should be understood by those of ordinary skill in the art that various changes in form and detail may be made therein without departing from the scope of the invention as recited in the accompanying claims.

What is claimed is:

1. A device for removal of excess material from a test sample, comprising:
a test geometry comprising a lower geometry and an upper geometry, wherein at least one of the upper geometry and the lower geometry is configured to move vertically with respect to the other of the upper geometry and the lower geometry; and
a trimming device includes:
a first arm extending to a first set of blades including a first blade and a second blade;
a second arm extending to a second set of blades including a third blade and a fourth blade; and
a linear track system,
wherein movement of the trimming device along the linear track system first engages the first blade and the third blade with an exterior of at least one of the upper geometry and the lower geometry, and then engages the second blade and the fourth blade with the exterior of the at least one of the upper geometry and the lower geometry.

2. The device of claim 1, further comprising a motorized actuator coupled to the linear track system, the motorized actuator configured to move the trimming device and each of the first arm and the second arm along the linear track system.

3. The device of claim 1, wherein the lower geometry comprises a circular lower plate and the upper geometry comprises a circular upper plate.

4. The device of claim 3, wherein an outer diameter of the lower geometry is greater than an outer diameter of the upper geometry.

5. The device of claim 1, wherein the first arm is bifurcated into the first blade and the second blade such that the first blade and the second blade extend in perpendicular directions, and wherein the second arm is bifurcated into the third blade and the fourth blade such that the third blade and the fourth blade extend in perpendicular directions.

6. The device of claim 1, wherein the first arm and the second arm are each flexible arms configured to elastically deform when the exterior of the upper geometry is engaged with at least one of the blades.

7. The device of claim 1, wherein the linear track system is a straight track system.

8. The device of claim 1, wherein the linear track system includes at least one curved portion, wherein the at least one curved portion is configured to match a curvature of the at least one of the upper geometry and the lower geometry.

9. The device of claim 1, wherein the first arm and the second arm are operably attached to at least one compression spring.

10. The device of claim 1, wherein the linear track system is a dual track structure including at least a first track and a second track.

11. The device of claim 10, wherein the trimming device further includes a holder device, wherein the first and second arms are operably connected to the holder device, and wherein the holder device extends between and is engaged with the dual track structure.

12. The device of claim 10, wherein the first arm is movably attached to the first track and wherein the second arm is movably attached to the second track.

13. The device of claim 12, further comprising a motorized actuator coupled to the linear track system, the motorized actuator configured to move the trimming device and each of the first arm and the second arm along the linear track system, wherein the motorized actuator comprises a first motorized actuator coupled to the first track to move the first arm and a second motorized actuator coupled to the second track to move the second arm such that the first arm and the second arm are independently moveable.

14. A method for removal of excess material from a test sample, the method comprising:
providing a sample material between a lower geometry and an upper geometry of a rheometer;
providing a trimming device including a first arm extending to a first set of blade including a first blade and a second blade, a second arm extending to a second set of blades including a third blade and a fourth blade, and a linear track system;
moving each of the first arm and the second arm along the linear track system of the trimming device; and
engaging the exterior of at least one of the upper geometry and the lower geometry with the first blade and the third blade and then engaging the exterior of the at least one of the upper geometry and the lower geometry with the second blade and the fourth blade during the moving.

15. The method of claim 14, further comprising moving the upper geometry vertically with respect to the lower geometry after providing the sample material between the lower geometry and the upper geometry.

16. The method of claim 15, further comprising:
removing excess of the sample material protruding from an exterior of the at least one of the upper geometry and the lower geometry during the engaging.

17. The method of claim 16, further comprising further moving each of the first arm and the second arm along the linear track system of the trimming device with a motorized actuator.

18. A blade device for removal of excess material from a test sample of a rheometer, comprising:
a first arm a first arm extending to a first set of blades including a first blade and a second blade, wherein the first arm is bifurcated into the first blade and the second blade such that the first blade and the second blade extend in perpendicular directions.

19. The blade device of claim 18, wherein the first arm is flexible and configured to elastically deform when at least one of the first blade and the second blade engages with an upper geometry of a rheometer.

20. The blade device of claim 19, further comprising:
a second arm extending to a second set of blades including a third blade and a fourth blade, wherein the second arm is bifurcated into the third blade and the fourth blade such that the third blade and the fourth blade extend in perpendicular directions.

21. A device for removal of excess material from a test sample, comprising:
a test geometry comprising a lower geometry and an upper geometry, wherein at least one of the upper geometry and the lower geometry is configured to move vertically with respect to the other of the upper geometry and the lower geometry; and
a trimming device includes:
a first dual arm structure including a first arm and a second arm, the first arm extending to a first blade and the second arm extending to a second blade;
a second dual arm structure including a third arm and a fourth arm, the third arm extending to a third blade and the fourth arm extending to a fourth blade; and
a linear track system,
wherein movement of the first dual arm structure and the second dual arm structure in a first linear direction engages the first blade and the third blade with an exterior of the upper geometry, and
wherein movement of the first dual arm structure and the second dual arm structure in a second linear direction engages the second blade and the fourth blade with the exterior of the upper geometry, wherein the second linear direction is opposite the first linear direction.

22. The device of claim 21, further comprising a motorized actuator coupled to the linear track system, the motorized actuator configured to move each of the first dual arm structure and the second dual arm structure along the linear track system.
